(19) United States
(12) Patent Application Publication
(10) Pub. No.: US 2022/0146644 A1
(43) Pub. Date: May 12, 2022

(54) MONOSTATIC SCANNING LIDAR USING A MULTI-FACETED POLYGON MIRROR AS ONE OF DUAL REDIRECTING ELEMENTS

(71) Applicant: Lumibird Limited, Ottawa (CA)

(72) Inventors: Derek BUTLER, North Gower (CA); Philip CHURCH, Stittsville (CA); Christopher GREBE, Windsor (CA); Michael SEKERKA-BAJBUS, Ottawa (CA)

(73) Assignee: Lumibird Limited, Ottawa, ON (CA)

(21) Appl. No.: 17/602,838

(22) PCT Filed: Apr. 12, 2019
(86) PCT No.: PCT/IB2019/053041

§ 371 Date: Oct. 11, 2021

(51) Int. Cl. G01S 7/481; G01S 17/89; G01S 17/10; G02B 26/10; G02B 26/12

(52) U.S. Cl. CPC G01S 7/4817; G01S 17/89; G02B 26/124; G02B 26/101; G01S 17/10

(57) ABSTRACT

A sensor comprises two independently rotatable elements. The first element comprises facets in a polygonal configuration fully rotatable about a first axis at a first angle relative to a source's beam axis and redirects energy incident on a facet at a second angle to a facet plane at a reflected angle equal in magnitude to the second angle as the first element is rotated. The second element may be a wedge mirror fully and independently rotatable about a second axis at a third angle to the beam axis that redirects energy at a fourth angle to the second axis, in a direction within the FOV, receives reflected energy to the first element for redirection toward an element interposed between it and the source that allows the source energy to pass unimpeded, and on to a detector. Correlating data from the detector and the source determines the target range.

### RELATED APPLICATIONS

Not Applicable

### TECHNICAL FIELD

The present disclosure relates to scanning LIDARs and in particular to a monostatic scanning LIDAR optical ranging sensor with dual redirecting elements.

### BACKGROUND

Optical ranging sensors for determining the profile of the surface of an object relative to a reference plane are known. In some applications, such sensors are often used to determine the range from the sensor to the object. Typically, they involve the transmission of an optical launch beam for reflection by the object and measurement of a scattered return beam from which the range to the object may be calculated. One such system is Light Detection And Ranging (LIDAR). Some LIDAR ranging systems measure the time of flight (TOF) of a collimated optical launch beam (typically using laser pulses) and its scattered return beam.

Monostatic LIDAR sensors, in which the launch beam and return beam are co-aligned, are relatively simple in structure. A simple example non-scanning monostatic LIDAR sensor is schematically shown in FIG. 1, in which the sensor 1 includes a beam source 2, typically a pulsed laser, a first lens 3, a beam splitter 4, a second lens 6, a detector 7 and a receiver unit 11. A launch beam 8, which may be a laser beam, emanating from the beam source 2, passes through the first lens 3 and beam splitter 4, projecting the launch beam 8 onto a target 10, whose range is to be measured. The series of reflecting and refracting elements through which the launch beam 8 is passed is known as the sensor head.

The beam splitter 4 receives laser light reflected back from the target 10 and is arranged so that the component of the returned light 9 between the target 10 and the beam splitter 4 is co-aligned with the launch beam 8. Thus, the returned light 9 impinges upon the detector 7.

The beam splitter 4 reflects the return beam 9 at some angle, which in some non-limiting examples may be 90° onto the detector 7 via the second lens 6. The range is measured by a receiver unit 11 based on correlation of information between the launch beam 8 and the detected returned light 9. Where the launch beam 8 is pulsed, a TOF technique may be employed based on the time interval between the pulsed launch beam 8 and detected returned light 9 and knowledge of the speed of light. In some non-limiting examples, where the launch beam 8 is a continuous wave (CW) signal, a phase detection technique may be employed based on the heterodyne phase difference between the CW launch beam 8 and detected returned light 9. In some non-limiting examples, where the launch beam 8 is a CW signal, a triangulation technique may also be employed.

In some examples, the beam splitter 4 could be replaced by a (parabolic) mirror (not shown) facing the target 10, with a central aperture to allow the launch beam 8 to pass through it.

In some examples, three-dimensional sensing may be obtained, by mounting the sensor on a pan-tilt unit that is re-oriented from time to time so that the launch beam 8 is reflected off different locations on the surface of the target 10, or by interposing an optical scanner (not shown) between the beam splitter 4 and the target 10 to control the beam direction and direct the launch beam 8 along a two-dimensional grid (usually designated as comprising X- (azimuthal) and Y-coordinate (elevational) values) substantially normal to the axis (Z-coordinate) of the launch beam 8 and defining a reference plane. In such examples, the Z-coordinate, lying on an axis of the launch beam 8 that is normal to the reference plane, measures the range for each (x,y) coordinate pair. In such an arrangement, the optical scanner also receives laser light reflected back from the target 10 and is arranged to maintain the co-aligned arrangement between the component of the returned light 9 and the launch beam 8 between the target 10 and the optical scanner, so as to ensure that the detector 7 images the returned light 9 regardless of scanning angle (a concept known as auto-synchronization).

The maximum angular direction, at which the launch beam 8 may be directed by the optical scanner while remaining auto-synchronized, defines the field of view (FOV) of the sensor. Generally, it is considered beneficial to have as large a FOV as possible. In particular, the use of optical ranging LIDAR sensors on such moving platforms, including without limitation, driver-assisted vehicles, benefit from a large FOV at least in a horizontal (azimuthal or X−) direction or orientation in order to identify incoming obstacles and provide an ability to avoid them.

Monostatic optics are often used in scanning LIDARs because of their relatively small mirror size. In some examples, it is beneficial to have as small a sensor package as possible. Moreover, in many applications for optical ranging sensors, the sensor is mounted on a moving platform, which may be ground-, underwater-, air- or even space-based, to detect objects in the platform's path or more generally, within its FOV, so as to allow the platform to be maneuvered toward, away or through the obstacles as desired, or alternatively to map the environment in which the platform is operating.

However, because monostatic LIDAR sensors co-align the returned light 9 with the launch beam 8, there is a risk that blooming from imperfections in the path of the launch beam 8 especially at extremely short range, may, if they lie in the path of the receiving optics, saturate the detector 7, leading to anomalous range calculations. For this reason, monostatic LIDAR sensors typically do not detect the returned light 9 from targets 10 that are within a few meters' range. Furthermore, because the power of the returned light 9 attenuates significantly as range increases, unless the detector 7 has an extremely high dynamic range, it also may not detect the returned light 9 if the target 10 is distant.

In computer vision applications, such as for navigation of a robot or of an autonomous vehicle, a scanning LIDAR is often employed to acquire 3D imagery. In some example applications, such as mobile sensor applications, the specifications of such scanning LIDARs are challenging.

In some examples, the scanning LIDAR sensor may be further constrained to occupy a small volume and have a small weight with low power consumption.

In US Patent Application Publication No. 2005/0246065 filed by Ricard on 3 May 2005 and published 3 Nov. 2005 and entitled “Volumetric Sensor for Mobile Robotics” there is disclosed a volumetric sensor for mobile robot navigation to avoid obstacles in the robot's path that includes a laser volumetric sensor on a platform with a laser and detector directed to a tiltable mirror in a first transparent cylinder that is rotatable through 360° by a motor, a rotatable cam in the cylinder tilts the mirror to provide a laser scan and distance measurements of obstacles near the robot. A stereo camera is held by the platform, that camera being rotatable by a motor to provide distance measurements to more remote objects.

The Ricard sensor employs a short-range off-the-shelf laser ranging system capable of providing measurements of less than substantially 50 m. The laser ranging system scans only 33 lines vertically in a 360° helical scan pattern in 1 s. Additionally, the scanning mechanism, employing a tiltable mirror, a protective cover and a window that is rotated with the mirror, is complex and may not be amenable to an increased scan rate.

Another such system is provided by Velodyne Lidar Inc. of Morgan Hill, Calif. The Velodyne model HDL-64 High Definition LIDAR is commonly found in autonomous vehicles. In the Velodyne system, the entire head, consisting of both scanning optics and electrical system) is spun. The scanning optics employs 64 pairs of lasers and detectors. Such a design employs special designs to pass data (at a rate of 1.3 M points per second) and power to the spinning head, which rotates at substantially 15 revolutions per second. The large number of pairs of lasers and detectors significantly affects the cost of the device.

Moreover, the Velodyne sensor spans only 64 lines in the vertical direction and has a short maximum range of substantially 120 m.

U.S. Pat. No. 4,871,904 issued 3 Oct. 1989 to Metlitsky et al and entitled “Multidirectional Optical Scanner” discloses a multidirectional scan pattern that is generated by two mirrors, each inclined at a tilt angle and rotated about an axis at an angular speed. The size and shape of the pattern are controlled by adjusting the tilt angles and the angular speeds.

The Metlitsky scanner acts as a bar code scanner and uses a continuous beam of energy with a faceted or oscillating element. The scan pattern has a void in the middle. Given the purpose for which the Metlitsky scanner is employed, this is in fact desirable, especially given that the energy is emitted in a continuous beam, because the void reduces the risk that the scanner will radiate energy at a customer's eye.

U.S. Pat. No. 7,336,407 issued 26 Feb. 2008 to Adams et al, and entitled “Scanner/Pointer Apparatus having Super-Hemispherical Coverage” discloses a scanner apparatus which has super-hemispherical coverage and includes a receiver, a pair of counter-rotating prisms, and a rotating mirror aligned with the pair of counter-rotating prisms. The rotating mirror and the pair of counter-rotating prisms guide an observed optical signal in afield of regard greater than that achievable through the use of only the pair of counter-rotating prisms. The apparatus may also include a laser that generates an optical signal guided by the prisms and the mirror toward an object of interest in the field of regard.

The prisms in the Adams et al apparatus are constrained in that they rotate in opposite directions and the rotational speed of one of the prisms is a function of the rotational speed of the other prism, that is, the prisms are not independently rotatable.

PCT International Patent Application Publication No. WO2013/177650 filed by Neptec Design Group Ltd. (“NDG”) on 26 Apr. 2012 and entitled “High Speed 360 Degree Scanning LIDAR Head” discloses a head for directing radiated energy from a source to a target at a coordinate in a field of view defined by at least one of azimuth and elevation, that comprises an angled element and a planar reflecting element. The angled element rotates about a first axis and redirects the beam, the redirection of the angled element differing in at least one of direction and extent as it is rotated. The reflecting surface rotates about a second axis parallel to the first. An axis normal to the surface extends at an angle to the second axis. The reflecting surface receives the redirected beam at a point thereon and reflects it in a direction within the FOV. A rotator may be positioned between the source and the angled element to support and independently rotate the angled element and the reflecting surface about the first and second axis without impeding the energy.

While the NDG LIDAR head has two rotating elements, an angled element and a planar reflecting element, that are independently rotatable, they are constrained in that the rotational axes of both elements are parallel and, in some examples, co-axial.

The NDG LIDAR head accomplishes this by a dual hollow shaft rotator to independently rotate the angled element and the reflecting surface and to allow the energy to be radiated from the source through the hollow shaft of the rotator onto the angled element. The hollow shaft rotator imposes practical limits on the minimum and maximum size of the NDG LIDAR head. The minimum size of the head is constrained by the fact that the energy beam that is directed onto the target passes through the hollow shaft. Unduly reducing the size of the head, and concomitantly the diameter of the hollow shaft, reduces the effective intensity of the return pulse energy. Since the energy is scattered by the target upon which it impinges, and not all of it will be reflected back to the detector, the reduction in the effective return pulse energy may impair the ability of the detector to gather sufficient energy in order to estimate the range to the target. At the same time, the maximum size of the head is constrained by the fact that the angled element and the reflecting surface are mounted onto the rotator and rotated thereby. Unduly increasing the size of the head, and concomitantly the diameter of the hollow shaft, increases not only the size of the angled element and the reflecting surface, but also the size of the rotator, and the load that will be borne by the motors driving them.

PCT International Patent Application No. PCT/CA2018/050566 filed 14 May 2018 by Neptec Technologies Corp. (NTC) and entitled “Dual Mirror Monostatic Scanning LIDAR Ranging Scanner” discloses a scanning ranging sensor (the first NTC sensor) that comprises first and second independently rotatable mirrors about respective axes. The first axis and the second axis are respectively at a first angle and a third angle relative to a source's incident radiation beam axis. The first mirror redirects the energy at a second angle to the first axis as it is rotated. The second mirror further redirects the redirected energy at a fourth angle to the second axis as it is rotated, in a direction within the FOV, receives returned energy from a target and redirects it to the first mirror to be further redirected toward an energy-redirecting element interposed between the source and the first mirror that allow unimpeded passage of the energy from the source, and redirects the returned energy to a detector. Correlating data from the detector with corresponding data from the source may determine the target range.

The first NTC sensor employs wedge mirrors for both the first and second mirrors. Various examples of the first NTC sensor respectively disclose a 60°×40° elliptical FOV (azimuth×elevation), a 64°×65° elliptical FOV and a 75° conical FOV. In the first NTC sensor, the azimuthal and elevational orientations of the FOV tend to be highly correlated and/or coupled and the intensity of energy directed within the FOV tends to be concentrated in the centroid thereof.

In some examples, LIDAR sensors have employed a multi-faceted reflecting mirror, also known as a polygon mirror, to produce a large horizontal FOV. One example of such a sensor is Metlitsky et al discussed elsewhere.

U.S. Pat. No. 5,006,721 issued 9 Apr. 1991 to Cameron et al and entitled “LiDAR Scanning System” discloses a LIDAR scanning system having a rotating multifaceted polygon mirror for transmitting modulated light from one of its facets to a surface. Diffuse light reflected off said surface is received by another facet of the polygon mirror and reflected to a photo detector. The phase difference between the transmitted and received light is then used to compute the range of the surface from the scanning system. The intensity of the returned light is used to create a gray scale image of the surface. The use of separate optical paths for the transmitted and returned light, and a small scanned field of view results in an improved signal-to-noise ratio.

Cameron et al employ a rotating eight-facet polygon mirror in combination with an orthogonal tilting mirror under galvonometer motor control. The laser is reflected by a polygon mirror in the horizontal direction and is reflected again in the vertical direction by the mirror driven by the galvonometer motor. While both the polygon mirror and the tilting mirror are capable of being independently rotated, the tilting mirror responds to voltages presented to the galvanometer motor and is tilted at an angle corresponding to the presented voltage. The Cameron et al, apparatus thus limits the movement of the tilting mirror to a limited angular tilt range and the tilting mirror is not fully rotatable through a complete 360° revolution. The apparatus measures range through frequency modulation of the laser emission, also known as frequency modulation (FM) continuous wave (CW) (FMCW).

The use of oscillating or rotating multi-faceted mirrors has also been extensively used to operate laser printers. Another type of application is for high-resolution displays.

An example of such an application is found in U.S. Pat. No. 6,351,324 issued 26 Feb. 2002 to Flint and entitled “Laser Imaging System with Progressive Multi-Beam Scan Architecture”. Flint discloses a progressive scan architecture for displaying a two-dimensional image by alternately scanning two or more laser beams, one after the other with a time delay between adjacent beams. The beams are arranged to become incident upon a polygon scanner in a row with an approximately uniform spatial separation and an approximately equal angle between adjacent beams. The polygon scanner scans horizontally and a galvanometer-driven mirror scans vertically. Adjacent lines are progressively scanned in sequence from top to bottom, which advantageously reduces or eliminates psycho-visual effects and is tolerant of non-linearities in the vertical scanner, allowing use of a low-cost galvo mirror. Typically, the beams in the row are arranged in pairs, and only one beam from each pair will be scanning at any one time. Embodiments are described in which the duty cycle is slightly less than 50% and the laser illumination is switched between two interleaved beam scans thereby allowing a single modulator to be used for both beams which provides significant cost advantages and improves system efficiency. For full-color images, each of the beams described can incorporate separate red, green and blue (RGB) components which are individually modulated by separate red, green, and blue modulators. The system can be scaled up with one or more additional pairs of beams to improve resolution and/or increase pixel count without requiring a high-speed polygon scanner or a highly-linear galvo scanner. Furthermore, the height of each facet in the polygon mirror need by only one beam diameter and its length need only be two beam diameters, which allows the system to approach the minimum pixel size attainable, which is useful to provide high efficiency and high brightness in the image.

A typical two-dimensional scanner uses a polygon scanner for horizontal scanning and a galvonometer-actuated mirror that oscillates but is not fully rotatable about at least a full revolution, for vertical scanning.

U.S. Pat. No. 7,598,848 issued 6 Oct. 2009 to Takagi et al. (Takagi No. 1) and entitled “Apparatus and Method of Pedestrian Recognition” discloses an apparatus having a laser radar that is used to recognize a pedestrian by detecting a position of reflective objects, mapping the objects in a two-dimensional coordinate system, determining whether the objects are moving, and grouping moving objects closely located with each other. Based on a size of an object group, the pedestrian associated with the object group is accurately recognized.

The Takagi No. 1 LiDAR system is equipped with a single element, namely a 6-facet rotating polygon for the purpose of detecting pedestrians and other obstacles from a moving vehicle. Each mirror of the polygon has a slight increasing angle of 1.6° resulting in the six mirrors reflecting light in six lines of different heights after a full rotation of the polygon. The resulting FOV is 36° (H)×8.6° (V). Distances to objects are calculated with Time-of-Flight (TOF) method.

U.S. Pat. No. 8,694,236 B2 issued 8 Apr. 2014 to Takagi (Takagi No. 2) and entitled “Road Environment Recognition Device and Method of Recognizing Road Environment” discloses a radar unit that emits beams, and receives a reflection beam reflected by an object. A position of the object relative to a vehicle and an attribute of the object are recognized based on the emitted beams and the reflection beam. A coordinate position of the vehicle in an absolute coordinate is calculated based on a traveling amount of the vehicle and a coordinate position of the object is calculated based on the calculated position of the vehicle and the position of the object relative to the vehicle. A road environment of the vehicle is recognized based on the coordinate positions and the attribute of the object.

Takagi No. 2 uses the apparatus of Takagi No. 1 to map, in 3D, the road details in front of the moving vehicle. This may include the delineation of the road lanes, the traffic sign, obstacles, incoming vehicles, etc.

This background information is provided to reveal information believed by the applicant to be of possible relevance to the present invention. No admission is necessarily intended, nor should be construed, that any of the preceding information constitutes prior art against the present invention.

### SUMMARY

It is an object of the present disclosure to obviate or mitigate at least one disadvantage of the prior art.

According to a broad aspect of the present disclosure, there is disclosed a head for directing energy radiated from a source along a beam axis to a coordinate in a FOV defined by at least one of azimuthal and elevational orientations, comprising: a first energy-redirecting element comprising a plurality of facets organized in a polygonal configuration, the facets being fully rotatable about a first axis that is at a first angle relative to the beam axis, for rotating the facets about the first axis, receiving the radiated energy incident along the beam axis on a facet facing the source at a second angle to a plane of the facet and redirecting it at a reflected angle having a magnitude equal to the second angle as the first energy-redirecting element is rotated; and a second energy-redirecting element fully and independently rotatable, in at least one of direction and rate relative to the first energy-redirecting element, about a second axis at a third angle to the beam axis, for rotating at least one complete revolution and receiving the redirected energy incident thereon and further redirecting it at a fourth angle to the second axis as it is rotated in a direction within the FOV.

In an embodiment, the FOV can have a substantially regular shape oriented along its azimuthal and elevational orientations. In an embodiment, the first energy-redirecting element can be associated with a controlled orientation of the FOV and the second energy-redirecting element can be associated with an uncontrolled orientation of the FOV. In an embodiment, the FOV can extend substantially 85° along the controlled orientation thereof. In an embodiment, FOV can extend substantially 21° along the uncontrolled orientation thereof.

In an embodiment, the first angle can be substantially 90°. In an embodiment, the facets can define a regular polygon. In an embodiment, the facets can each be mirror surfaces for reflecting the radiated energy incident thereon at the reflected angle.

In an embodiment, a third axis, the beam axis and the first axis can define a right-handed cartesian coordinate system. In an embodiment, each of the facets can substantially define a plane having an associated normal vector. In an embodiment, the plane of each facet can be substantially parallel to the first axis and the associated normal vectors can all lie in a common plane normal to the first axis. In an embodiment, the common plane can be defined by the third axis and the beam axis and the first energy-redirecting element can be associated with the azimuthal orientation of the FOV. In an embodiment, the common plane can be defined by the beam axis and the first axis and the second energy-redirecting element can be associated with the elevational orientation of the FOV. In an embodiment, at least one facet can be offset by a facet offset angle. In an embodiment, the facet offset angle can be substantially less than 10°. In an embodiment, a projection of the second axis onto a first plane defined by the third axis and the beam axis can be substantially along the third axis and a projection of the second axis onto a second plane defined by the third axis and the first axis can be substantially at 45° with the first axis. In an embodiment, the second axis can be subjected to at least one positioning adjustment relative to the projection thereof onto at least one of the first and second planes.

In an embodiment, the fourth angle can be substantially between 0° and 15°. In an embodiment, the second energy-redirecting element can be a second mirror surface. In an embodiment, the second energy-redirecting element can be a substantially circular wedge mirror angled at the fourth angle relative to a base normal to the second axis.

According to a broad aspect of the present disclosure, there is disclosed a method for directing energy radiated from a source along a beam axis to a coordinate in a FOV defined by at least one of azimuthal and elevational orientations, comprising actions of: rotating a first energy-redirecting element comprising a plurality of facets organized in a polygonal configuration completely about a first axis that is at a first angle relative to the beam axis; directing the energy from the source onto the first energy-redirecting element at a second angle to a plane thereof: redirecting the energy incident on the first energy-redirecting element, at a reflected angle having a magnitude equal to the second angle, toward a second energy-redirecting element; independently rotating, in at least one of direction and rate relative to the first energy-redirecting element, the second energy-redirecting element completely about a second axis at a third angle to the beam axis; and further redirecting the energy incident on the second energy-redirecting element, from the first energy-redirecting element, at a fourth angle to the second axis in a direction within the FOV.

Embodiments have been described above in conjunction with aspects of the present disclosure upon which they can be implemented. Those skilled in the relevant art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Some aspects and embodiments of the present disclosure may provide a dual redirecting element monostatic scanning LIDAR using a multi-faceted polygon mirror as one of the elements and a head therefor.

### BRIEF DESCRIPTION OF THE DRAWINGS

Example embodiments of the present disclosure will now be described by reference to the following figures, in which identical reference numerals in different figures indicate identical elements and in which:

FIG. 1 is a schematic diagram of a non-scanning monostatic LIDAR optical ranging sensor:

FIG. 2 is a schematic view of an example head for a monostatic scanning LIDAR using a multi-faceted polygon mirror element as one of dual redirecting elements according to an example;

FIG. 2A is a side cross-sectional view of the second redirecting element of FIG. 2 according to an example;

FIG. 3 is an example perspective schematic view of the sensor of FIG. 2, according to an example;

FIG. 4 is an isometric view showing the sensor of FIG. 2 within an enclosure with an aperture cover;

FIG. 5 is an example schematic diagram illustrating respective contributions of the multi-faceted polygon mirror element and the second redirecting element of FIG. 2 to produce the FOV of the head of FIG. 2 according to an example;

FIG. 6 is a print out of an example of traces of a simulated projection of the second redirected launch beam in the launch portion of the sensor of FIG. 2; and

FIG. 7 is a flow chart showing method actions according to an example.

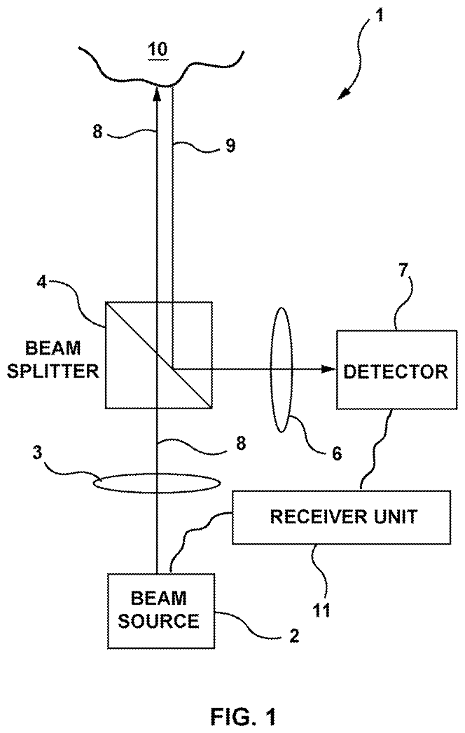

In the present disclosure, for purposes of explanation and not limitation, specific details are set forth in order to provide a thorough understanding of the present disclosure. In some instances, detailed descriptions of well-known devices and methods are omitted so as not to obscure the description of the present disclosure with unnecessary detail.

Accordingly, the system and method components have been represented, where appropriate, by conventional symbols in the drawings, showing only those specific details that are pertinent to understanding the embodiments of the present disclosure, so as not to obscure the disclosure with details that will be readily apparent to those of ordinary skill in the art having the benefit of the description herein.

### DESCRIPTION

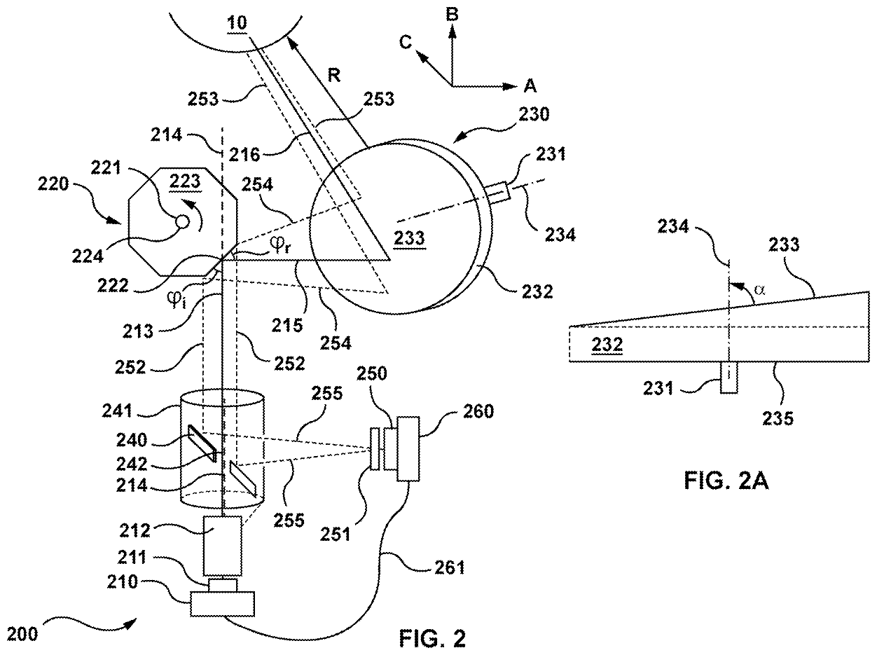

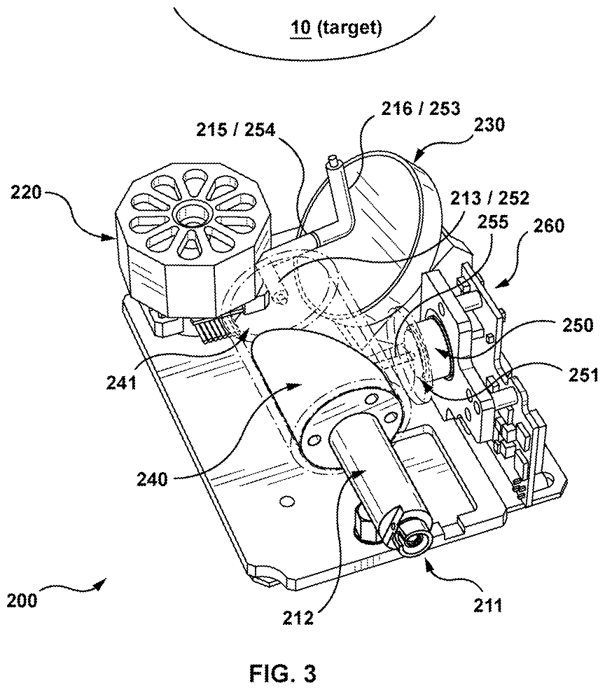

Turning now to FIG. 2 there is shown a schematic view of an example of a head of a monostatic scanning LIDAR optical ranging sensor, shown generally at 200, using a multi-faceted reflecting mirror, also known as a polygonal mirror, as a first (energy-)redirecting element 223, of dual redirecting elements 223, 233 according to the present disclosure. FIG. 3 shows a complementary perspective schematic view of the sensor 200 according to the present disclosure.

In some examples, the sensor 200, may be understood to incorporate, in some respects, the first NTC sensor, but where the first independently rotatable mirror, which, in some examples disclosed in the first NTC sensor, was a (first) wedge mirror, is replaced with the multi-faceted polygonal first redirecting element 223. Because of the differing configuration of the first wedge mirror in the first NTC sensor (the first motor shaft is substantially normal to the first motor mount on which the first wedge mirror is mounted at an angle) and the first redirecting element 223 in the sensor 200 (the first motor shaft 221 is substantially parallel to the planes of each of the facets 222 of the first redirecting element 223), the axis of the corresponding first motor shaft 221 driving the first redirecting element 223 in the sensor 200 is substantially normal to the axis of the first motor shaft driving the first wedge mirror in the first NTC sensor.

As will be discussed elsewhere, one of such orientations is primarily controlled by the first redirecting element 223. Such controlled orientation, which depending upon the orientation of the first motor shaft 221 (in FIG. 2 parallel to the C-axis) may be the azimuthal orientation (which is the case in FIG. 2) or the elevational orientation, tends to be expanded relative to that of the FOV of the first NTC sensor, all other things being substantially equal.

Additionally, relative to the configuration of the first NTC sensor, the sensor 200 has a FOV where the controlled (in FIG. 2 the azimuthal) orientation thereof is substantially decoupled from that of the other (in FIG. 2 the elevational) orientation thereof.

Further, as a result of the decoupling of the controlled and uncontrolled orientations of the FOV, the FOV tends to have a more rectangular than elliptical or conical shape than that of the first NTC sensor.

Still further, the use of the first redirecting element 223 in the sensor 200 tends to more evenly distribute the energy across the controlled (in FIG. 2, the azimuthal) orientation of the FOV relative to the FOV of the first NTC sensor. This more even energy distribution has two complementary and salutary implications. First, for a given rated power of the beam source 210, there is less concern about eye safety near the centroid of the FOV. Second, the rated power of the beam source 210 may be increased while continuing to satisfy prevailing eye safety considerations, which may correspondingly increase the effective range R of the sensor 200 and/or the ability of the sensor 200 to deal with an increased density of obscurants between the sensor 200 and the target 10.

In some non-limiting examples, the first redirecting element 223 may be comprised of one or more refractive elements (not shown) as opposed to a multi-faceted reflecting mirror as shown. In some non-limiting examples, such (set of) refractive element(s) may comprise Risley prisms. Those having ordinary skill in this art will appreciate that using such (set of) refractive element(s) may cause the axis of the corresponding first motor shaft 221 driving it to be different from what is shown in FIG. 2. Further, using such (set of) refractive element(s) may cause the two orientations of the resulting FOV to be more highly coupled than the example shown in FIG. 2.

FIG. 2 also shows a right-handed cartesian coordinate system with mutually orthogonal axes by which the orientation of orientations of the sensor 200 may be identified, respectively designated A, B and C and in which the A-axis extends to the right in the plan view of FIG. 2, the B-axis extends upward and in the direction of the beam axis 214 in the plan view of FIG. 2 and the C-axis extends normally outward from the plan view of FIG. 2.

The sensor 200 comprises a beam source 210, a first redirecting assembly 220, a second redirecting assembly 230, a third redirecting element 240, a detector 250 and a receiver unit 260.

The sensor 200 may be considered as comprising a launch portion and a detection portion. The launch portion of the sensor 200 may be considered to employ the beam source 210, the first redirecting assembly 220 and the second redirecting assembly 230. The detection portion of the sensor 200 may be considered to employ the first redirecting assembly 220, the second redirecting assembly 230, the third redirecting element 240, the detector 250 and the receiver unit 260.

Considering first the launch portion of the sensor 200, the beam source 210 generates a launch beam 213 along a beam axis 214 that extends parallel to and along the positive B direction.

In some non-limiting examples, the beam source 210 may be a fiber or other form of laser. In some examples, the beam source 210 may be a LED laser. In some non-limiting examples, the wavelength of the launch beam 213 may be 1550 nm. In some non-limiting examples, the rated power of the beam source 210 may be between substantially 300 mW and 2 W. However, the beam source 210 may be provided with a substantially larger (or smaller) rated power depending upon the desired range, capability and/or sensitivity of the sensor 200.

The ability to image a target 10 at a given range R of the sensor 200 may depend upon one or more of the rated power of the beam source 210, the sensitivity of the detector 250 and/or how much power is returned from the target 10 and is redirected to the detector 250.

In some non-limiting examples, the wavelength of the launch beam 213 and/or the rated power of the beam source 210 may be constrained by prevailing eye safety considerations.

In some non-limiting examples, the launch beam 213 is pulsed at a pulse repetition frequency (PRF) that may range, without limitation, from as low as 0 Hz (in the case of a CW beam) to a maximum capability supported by the sensor 200, recognizing that the effective range of the sensor 200 would decrease as the PRF increases. In some non-limiting examples, the launch beam 213 is a continuous beam. In some non-limiting examples, the launch beam 213 is an FMCW beam, especially if, as discussed elsewhere, heterodyne detection of the phase difference is used to determine the range R to the target 10.

In some non-limiting examples, the beam source 210 is coupled to the receiver unit 260 by a signal line 261 such that the receiver unit 260 can correlate the emission of the launch beam 213 with the receipt of a signal corresponding thereto by the detector 250 and determine the range R to the target 10 therefrom.

In some non-limiting examples, the time that the (pulsed) launch beam 213 is emitted is correlated with the time at which the corresponding signal is detected at the detector 250 to determine a time of flight (TOF) to and from the target 10 from which the range R thereto may be determined.

In some non-limiting examples, the phase at which the (CW) launch beam 213, which in some non-limiting examples would be a FMCW beam, is emitted, is correlated with the phase at which the corresponding signal is detected by heterodyne detection at the receiver unit 260, to determine a phase difference, from which the range R to the target 10 may be determined, although it will be appreciated that the specific configuration in such case would be different and may involve different and/or additional components from that shown in FIG. 2 and as described herein.

In some non-limiting examples, the beam source 210 comprises a laser beam collimator 212, for collimating the launch beam 213 passing through it, to restrict or inhibit its divergence from the beam axis 214. Additionally, in some non-limiting examples, the collimator 212 may expand the launch beam 213 to a diameter that is suitable so that its energy density is sufficiently low, relative to the rated power of the beam source 210 and the wavelength(s) emitted, to satisfy prevailing eye safety considerations.

The first redirecting assembly 220 comprises a first motor (not shown), a first motor shaft 221 coupled thereto and lying along a first axis 224 that is at a first angle to the beam axis 214, a first mount (not shown) lying in a plane normal to the first motor shaft 221 (as shown in FIG. 2, in the A-B plane) and coupled to the first motor shaft 221, and a first redirecting element 223 coupled to the first mount, which in some non-limiting examples, may be a facet 222 of a multi-faceted or polygonal element on which the launch beam 213 is incident.

In some non-limiting examples, the first angle between the first axis 224 and the beam axis 214 may be 90°.

In some non-limiting examples, each of the facets 222 may be a mirrored surface for reflecting the launch beam 213, incident thereon at a second (incident) angle (ϕᵢ) relative to the plane of the facing facet 222, at a reflected angle (ϕᵣ) having a magnitude equal to 4, in which case the polygonal first redirecting element 223 may be a polygonal mirror.

In the orientation of the first motor shaft 221 shown in FIG. 2, as discussed elsewhere, the first redirecting assembly 220 is associated with the controlled azimuthal direction or orientation of the FOV and consequently, the second redirecting assembly 230 is associated with the elevation direction or orientation of the FOV. Typically, such orientation may be employed where it is desirable to have a FOV with a controlled azimuthal orientation that is long relative to its elevational orientation.

In some non-limiting examples, as shown in FIG. 2, the first motor shaft 221, which lies along the first axis 224, may lie parallel to and along the positive C-axis, in which case the first mount lies in the A-B plane and the positive A-axis may be considered to be a third axis that with the beam axis 214 and the first (positive-C) axis, 224 defines a right-handed cartesian coordinate system.

In some non-limiting examples, the surface of each of the facets 222 may be substantially rectangular in shape and lie in a plane parallel to the C-axis and orthogonal to the A-B plane, with the normal vector of each facet 222 lying in the A-B plane. Thus, as discussed elsewhere, the first motor shaft 221 lies along a first axis 224 that is substantially parallel to the plane of each of the facets 222 of the first redirecting element 223.

In some non-limiting examples, at least one of the facets 222 of the first redirecting element 223 may be provided with a small facet offset (not shown in FIG. 2), which in some non-limiting examples, may be a small number (such as by way of non-limiting example, less than 10°) (or a fraction thereof) of degrees, of the normal vector of each facet 222 on one or the other side of the A-B plane. Such facet offset(s) may, as discussed elsewhere, facilitate distribution of the first redirected launch beam 215 at a reflected angle (ϕᵣ) to the second angle (ϕᵢ) that may be substantially of equal magnitude but on the opposing side of the normal vector of the facing facet 222, onto different areas of the second redirecting surface 233 and provide an increase in the extent of the uncontrolled (elevational) orientation of the FOV.

Those having ordinary skill in the relevant art will appreciate that the surface of each of the facets 222 may still lie (ignoring the possibility of the (small) facet offset, if any) in a plane parallel to the C-axis (but be orthogonal to the B-C plane, with the normal vector of each facet 222 lying (subject to the facet offset, on one or the other side thereof) in the B-C plane. In such an alternative orientation, the first motor shaft 221, which lies along the first axis 224, may lie along and parallel to the positive A-axis (so that the first motor shaft 221 continues to lie along a first axis 224 that is substantially parallel to the plane of each of the facets 222 of the first redirecting element 223) and the positive C-axis may be considered to be the third axis that with the beam axis 214 and the first (positive-A) axis 224 still defines a right-handed cartesian coordinate system. In such an alternative configuration, the first mount lies in the B-C plane and the first motor shaft 221 remains normal to the beam axis 214. Further, as discussed elsewhere, the first redirecting assembly 220 controls or is otherwise associated with the elevational orientation of the FOV and consequently, the second redirecting assembly 230 is associated with the azimuthal orientation of the FOV. Typically, such alternative configuration may be employed where it is desirable to a FOV with a controlled elevational orientation that is long relative to its azimuthal orientation.

Nevertheless, for simplicity of description, going forward, only the configuration shown in FIG. 2 will be described.

However configured, in some non-limiting examples, each of the facets 222 of the first redirecting element 223 have substantially identical dimensions such that, viewed from the plan view along the C-axis, the first redirecting element 223 defines a regular polygon.

The first motor is coupled to the first motor shaft 221 at a first end and can fully or completely rotate the first motor shaft 221 in at least one of the clockwise and counter-clockwise directions in the A-B plane at a selectable rotation rate. In some non-limiting examples, the first motor can fully rotate the first motor shaft 221 about the first axis 224 thereof in both the clockwise and counter-clockwise direction. In some non-limiting examples, the first motor shaft 221 may be completely rotated at a rate between substantially 0 rpm and on the order of multiples of 1,000 rpm. The first motor shaft 221 and thus the first redirecting element 223 is fully rotated by the first motor through a plurality of complete revolutions.

The first redirecting assembly 220 is positioned such that the launch beam 213, which exits the collimator 212 and proceeds unimpeded along the beam axis 214 in the positive B direction thereafter, including through the third redirecting element 240, impinges on the surface of a (facing) facet 222 of the first redirecting element 223. Thus, as the first motor fully rotates the first motor shaft 221 through multiple complete revolutions, the first redirecting element 223 coupled thereto rotates accordingly, presenting one or another of the various facets 222, as the facing facet thereof, to the launch beam 213. The launch beam 213 impinges on the facing facet 222 and is redirected in a first redirected launch beam 215, substantially (subject to the presence of the facet offset, if any) along the A-B plane at a second angle onto the second redirecting element 230 as the first redirecting element 223 is rotated. In some non-limiting examples, the second angle (ϕᵢ) may be 45°, in which case, in some non-limiting examples, the reflected angle (ϕᵣ) at which the redirected radiation from the facing facet 222 is redirected is also substantially 45°. In some non-limiting examples, the redirected radiation from the facing facet 222 is evenly distributed about a range of angles, due to the rotation of the facing facet 222 about the first axis 224. The angular position of the facing facet 222 determines the direction (substantially within the A-B plane) of the redirected radiation. In some non-limiting examples, the redirected radiation is incident at a plurality of locations on and substantially across the extent of the second redirecting element 233.

The number n of facets 222 forming the first redirecting element 223 will determine the maximum angle that the launch beam 213 impinging on the facing facet 222 will be redirected. Provided that the dimensions of each of the facets 222 are substantially identical, the maximum angular direction, which will increase as the number n of facets 222 decreases, will be substantially 360°/n. In some non-limiting examples, the first redirecting element 223 has n=10 facets such that the maximum angular redirection is 36°.

Additionally, the number n of facets 222 acts as a multiplier of sorts of the rotational velocity of the first motor shaft 221 in that, relative to a hypothetical single faceted mirror being rotated by the first motor at the same rotational velocity (such as, without limitation, the first wedge mirror in the first NTC sensor), the number of scans in the controlled (azimuthal) orientation of the FOV by the first redirecting element 223 will be substantially n times greater than that of such hypothetical single faceted mirror. This allows a larger spacing between adjacent data points within the FOV, which tends to provide a more even and diffuse distribution of energy within the FOV.

The second redirecting assembly 230 comprises a second motor (not shown), a second motor shaft 231 coupled thereto and lying along a second axis 234 that is at a third non-zero angle to the beam axis 214 and in some non-limiting examples, at a non-zero angle to the first axis 224, a second mount 232 coupled to the second motor shaft 231 and a second redirecting element 233 coupled to the second mount 232. In some non-limiting examples, the second redirecting element 233 may be a second mirror surface. In some non-limiting examples, the second redirecting element 233 may be substantially circular in shape.

The second motor is coupled to the second motor shaft 231 at a first end and can fully or completely rotate the second motor shaft 231 along the second axis 234 in at least one of the clockwise and counter-clockwise directions at a selectable rotation rate. In some non-limiting examples, the second motor can fully rotate the second motor shaft 231 about the second axis in both the clockwise and counter-clockwise direction. In some non-limiting examples, the second motor shaft 231 may be completely rotated at a rate between substantially 0 and on the order of multiples of 1,000 rpm. The second motor shaft 231 and thus the second redirecting element 223 is fully rotated by the second motor through a plurality of complete revolutions.

In FIG. 2, both the first motor shaft 221 (along the first axis 224) and the second motor shaft 231 (along the second axis 234) are shown as rotating in the counter-clockwise direction. However, the first motor shaft 221 and the second motor shaft 231 are independently rotatable both in terms of speed and direction.

In some non-limiting examples, the second redirecting assembly 230 comprises a circular wedge mirror in which the mirror surface comprises the substantially circular second redirecting element 233 and is coupled to an angled surface of the second mount 232 having a wedge-shaped cross-section such as is shown in FIG. 2A. In such examples, the second motor shaft 231 is coupled at a second end to a second base 235 of the second mount 232. In some non-limiting examples, the second base 234 of the second mount 232 defines a plane normal to the axis of the second motor shaft 231.

The second mount 232 supports the mirror surface of the second redirecting element 233 thereon at a fourth angle, denoted a, to the second axis 234 of the second mount 232. In some non-limiting examples, the second mount 232 comprises a triangular prism-shaped structure having two identical right-angle triangle-shaped faces and three rectangular faces whose opposing sides are corresponding sides of the triangle. One of the rectangular faces adjacent to the right angle of the triangle forms the second base 234 of the second mount 232. The surface of the second redirecting element 233 is parallel to, supported by and coupled to the rectangular face opposite to the right angle of the triangle. The face opposite the right angle is thus at an angle (90°−α) to the face that forms the second base 235 of the second mount 232. In some non-limiting examples, the angle (90°−α) may be in the range of substantially 0° to 15°. Using a larger angle (90°−α) (or consequently, a smaller angle α) may constrain the ability of the surface of the second redirecting element 233 to capture all the beams redirected by the facing facet 222 of the first redirecting element 223 and may adversely impact the amount of the first redirected column 254 (described elsewhere) that may be captured by the sensor 200 for use by the detector 250.

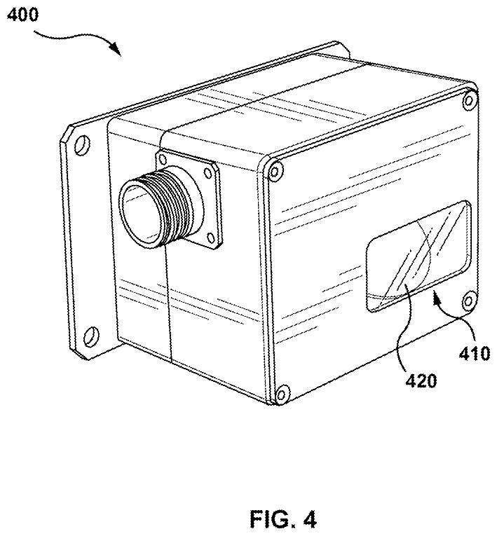

In some non-limiting examples, the projection of the second axis 234 of the second motor shaft 231 in the A-B plane is substantially along the A-axis whereas its projection in a plane defined by the A-axis and C-axis (the A-C plane) is substantially at 45° with the C-axis. In some non-limiting examples, the projection of the second axis 234 in at least one of the A-B plane and the A-C plane may be subject to a small positioning adjustment on the order of a few degrees. Such positioning adjustment(s) may be used to more finely position the intersection of the azimuthal axis and the elevational axis of the FOV to a desired location, such as, without limitation, to better center the projected FOV out of the enclosure aperture 410 of the enclosure 400 (FIG. 4) (in the case of an adjustment in the A-B plane) and/or to better center the FOV extent out of the window (in the case of an adjustment in the A-C plane). In some non-limiting examples, a positioning adjustment of a few degrees may be applied relative to the projection of the second axis 234 in the A-B plane.

The second redirecting assembly 230 is positioned such that the first redirected launch beam 215, which is redirected off the facing facet 222 of the first redirecting element 223 at the reflected angle (ϕᵣ) and proceeds unimpeded thereafter, impinges on the second mirror surface 233. Thus, as the second motor rotates the second motor shaft 231 through a plurality of complete revolutions, the second redirecting assembly 230 rotates with a nutation determined by the angle (90°−α) of the plane of the surface of the second redirecting element 233 relative to the second base 235 of the second mount 232, so that the first redirected launch beam 215 impinges upon the second mirror surface 233 and is redirected at an angle ta relative to the second axis 234 of the second motor shaft 231 outward in a second redirected launch beam 216 toward the target 10. The amount of nutation depends upon the angle (90°−α). The bearing of the second redirected launch beam 216 depends in part upon the instantaneous rotational angle of the first redirecting element 223 and the incident angle (ϕᵢ) presented to the launch beam 213 by the facing facet 222 thereof (which dictates the reflected angle (ϕᵣ) of the first redirected launch beam 215 on the surface of the second redirecting element 233) and upon the instantaneous rotational angle of the surface of the second redirecting element 233.

In some non-limiting examples, the second redirecting element 233 may be a refractive element (not shown) that causes the first redirected launch beam 215 to be refracted at an angle ±α relative to the axis of the second motor shaft 231 in the second redirected launch beam 216.

Turning now to FIG. 4, there is shown an example of the sensor 200 within an enclosure 400. The enclosure 400 comprises an enclosure aperture 410, in a lateral face thereof, through which the second redirected launch beam 216 may exit the enclosure 400. In some non-limiting examples, the enclosure aperture 410 is sized to substantially permit the second redirected launch beam 216 to substantially occupy the entire available FOV.

In some non-limiting examples, the enclosure aperture 410 of the enclosure 400 may be fitted with a radiation-permeable cover 420, comprising a material that is transparent at the frequency of the second reflected launch beam 216, including without limitation, any one or more of acrylic, polycarbonate, glass and/or crystal, to protect the components of the sensor 200 both physically and from dust and other contaminants.

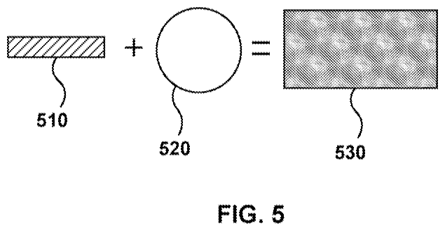

FIG. 5 is an example schematic diagram that illustrates respective contributions of the first redirecting assembly 220 and the second redirecting assembly 230 shown in FIG. 2 in the formation of the FOV of the sensor 200. The redirection, by the first redirecting element 223 of the launch beam 213, which is incident on the facing facet 222 at the second angle (ϕᵢ), toward the second redirecting element 233 at the reflected angle (or), tends to produce a rectilinear FOV 510 that is oriented substantially parallel to the B-axis, that is, a substantially horizontal or azimuthal orientation.

By contrast, the redirection of a notional beam (not shown) onto the second redirecting element 223 towards the target 10 tends to produce a circular FOV 520 oriented substantially equally in both the horizontal or azimuthal orientation and in the vertical or elevational orientation (substantially parallel to the A-axis). The combination of the rectilinear FOV 510 and the circular FOV 520 by successive redirection of the launch beam 213 by the first redirecting element 223 and then the second redirecting element 233 tends to produce a rectangular FOV 530 with a greater extent in the horizontal or azimuthal orientation (parallel to the B-axis) relative to the vertical or elevational orientation (parallel to the A-axis).

As discussed elsewhere, the first redirecting assembly 220 reflects the launch beam 213 incident on a facing facet 222 of the first redirecting element 223 in the first redirecting assembly 220 as the first redirected launch beam 215, which in turn is incident on the second redirecting element 233 of the second redirecting assembly 230.

Also as discussed elsewhere, in some non-limiting examples, the direction of the second motor shaft 231, when projected in the A-B plane is, subject to any positional offset, substantially in the direction of the positive A-axis and when projected in the A-C plane is substantially at 45° relative to the C-axis.

As the facing facet 222 of the first redirecting element 223 rotates, the first redirected launch beam 215 is redirected by the second redirecting element 233 substantially along the B-axis, subject to the angle (90°−α). If the angle (90°−α) was zero, the second redirecting element 233 would redirect the second redirected launch beam 216 substantially along the positive B-axis, with substantially no A-component, resulting in an FOV that was substantially rectilinear. However, since the angle (90°−α) is not zero, the second redirecting element 233 redirects the second redirected launch beam 216 with an additional component in the A-direction, as a result of the angle (90°−α). Accordingly, the resulting FOV, which is projected in the C-direction, will have a substantially rectangular shape with major and minor axes extending substantially in the A- and B-directions.

The extent of the FOV in the B-direction will be substantially twice the total angular redirection provided by the redirection by the facing facet 222 of the first redirecting element 223, with a further (minor) contribution from the redirection by the second redirecting element 233 at the angle (90°−α). The extent of the FOV in the A-direction will be largely determined by the value of the angle (90°−α). Therefore, the launch portion of the sensor 200 distributes the second redirected launch beam 216 in a FOV of substantially rectangular dimension toward the target 10. Such rectangular FOV may be, in some non-limiting cases, be appropriate to illuminate approaching targets 10 in the forward direction of a moving platform to which the sensor 200 is coupled.

The operation of the launch portion of the sensor 200 may now be described. It will be appreciated that while the operation of the detection portion of the sensor 200 is being described independently of the operation of the launch portion of the sensor 200, both the launch portion and the detection portion operate simultaneously and employ common components.

The first redirecting element 223 is fully or completely rotated in a first direction through at least one complete revolution and at a first constant rotational rate and the second redirecting element 233 is fully or completely independently rotated in a second direction through at least one complete revolution and at a second constant rotational rate. The first and second directions may be the same or different and the first and second constant rotational rates may be the same or different.

The beam source 210 emits a (pulsed) launch beam 213 and provides data to the receiving unit 260 along signal line 261 by which the launch beam 213 may be correlated with corresponding returns detected in the detection portion (described elsewhere) of the sensor 200 to determine the range R to the target 10. The launch beam 213 passes through and is conditioned by the collimator 212 and impinges at the incident angle (ϕᵢ) on the facing facet 222 of the first redirecting element 223, being redirected at the reflected angle (ϕᵣ) as the first redirected launch beam 215 that impinges on the second redirecting element 233, whereupon it is redirected as the second redirected launch beam 216 outwardly toward the target 10 in a substantially rectangular scan pattern. As discussed below, the launch beam 213 passes unimpeded through an aperture 242 in the third redirecting element 240, which is positioned between the beam source 210 and the first redirecting element 222. In some non-limiting examples, an optical shroud 241 may also be used to minimize internal reflections potentially collected by the third redirecting element 240.

The actual scan pattern of data points that will be displayed in the steady state depends upon a number of factors, including without limitation, the pulse rate, the total scan time, the rotational direction and/or frequency of the first motor shaft 221, the number n of facets of the first redirecting element 220, the rotational direction and/or frequency of the second motor shaft 231, the angle (90°−α) of the second redirecting element 233, the angle between the first axis 224 and the second axis 234 and the separation between the facing facet 222 of the first redirecting element 223 and the second redirecting element 235.

Adjusting the angle (90°−α) as well as the size of the facets 222 of the first redirecting element 223 and the size of the surface of the second redirecting element 233, will correspondingly vary the FOV achievable. In some non-limiting examples, an 85°×21° rectangular FOV (azimuth×elevation) (oriented respectively along the B-axis and the A-axis) may be achieved by the sensor 200.

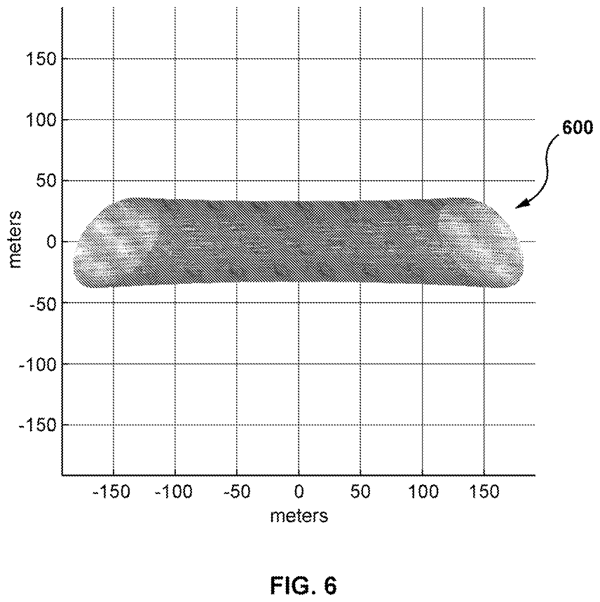

FIG. 6 illustrates this concept. In these figures, traces of the second redirected launch beam 216 have been recorded for a number of simultaneous rotations of the first motor shaft 221 and of the second motor shaft 231 as they impinge upon a surface of the target 10. What can be seen is that substantially linear traces are formed in the horizontal direction over a smaller vertical extent, created by the simultaneous and independent rotation of the second redirecting element 233. As the number of rotations increases the FOV is progressively filled.

The rotational speeds of the first motor shaft 221 and of the second motor shaft 231 and/or the phase relationship if any between them impact the form and density of the scan pattern.

It will also be appreciated that the separation between the facing facet 222 of the first redirecting element 223 and the second redirecting element 233 may impact the size of the second redirecting element 233. As a general rule, the lower the number n of facets 222 in the first redirecting element 223, the larger will be the size of the second redirecting element 233 in order to capture the first redirected launch beam 215 thereon, for a given separation between the first redirecting element 223 and the second redirecting element 233.

Subject to such constraints as well as power and/or cooling considerations, those having ordinary skill in the relevant art will appreciate that there are no practical limits to how large and/or how small the sensor 200 may be made. In some non-limiting examples, the enclosure 400 of the sensor 200 may be further reduced in size by housing the beam source 210 outside the enclosure 400 (not shown). In such circumstances, the launch beam 213 is passed into the enclosure 400 by a fibre (not shown) and data from the beam source 210 may be sent to the receiving unit 260 by means of a ribbon cable (not shown).

FIG. 6 shows a non-limiting example simulation of scans made using the launch portion of the sensor 200. By way of non-limiting example, the scan 600 shown in FIG. 6 reflects a pulse repetition frequency (PRF) of 500 kHz, a scan time of 0.3 s, a (counterclockwise, when seen from above) rotational frequency for the first motor shaft 221 of 5,000 Hz, a (counterclockwise, when seen from above) rotational frequency for the second motor shaft 231 of 4,700 Hz, an angle (90°−α) of the second redirecting element 233 of 4.6°, a separation between the facing facet 222 of the first redirecting element 223 and the second redirecting element 233 of 2.2 cm, an angle of 45° between the first axis 224 and the second axis 234 and a range R to the target 10 of 200 m. The ratio of the rotational frequency of the facets 222 of the first redirecting element 223 driven by the first motor shaft 221 to the rotational frequency of the second redirecting element 233 driven by the second motor shaft 231 is thus 10.62. The example scan 600 provides a FOV of 85°×21°.

Turning now to the detection portion of the sensor 200, the impingement on the target 10 of at least a portion of the scan pattern in the FOV generated by the second redirected launch beam 216 will be redirected by the target 10 as a wall of return radiation 253. In some non-limiting examples, the return radiation 253 is incident at a plurality of locations on and substantially across the extent of the second redirecting element 233.

The directionality and intensity of the return radiation 253 may be impacted, to a greater or lesser degree by any one or more of, without limitation:
the transmitted power of the launch beam 213;
the cross-sectional size of the launch beam 213;
the reflectivity of the target 10;
a the physical orientation of the target 10 with respect to the second redirected launch beam 216;
the size of the target 10;
the range R of the target 10 from the sensor 200; and
other factors, including without limitation, the presence and/or density of obscurants between the sensor 200 and the target 10.

As a result, some but potentially not all, of the return radiation 253, which is reflected by the target 10, will impinge upon the second redirecting element 233.

In some respects, the second redirecting element 233 may be said to “sample” the wall of return radiation 253. The parameters of the sensor 200, including without limitation, the FOV, the angle (90°−α), the size of the facets 222 of the first redirecting element 223, the size of the second redirecting element 233 and the separation between the second redirecting element 233 and the facing facet 222 of the first redirecting element 223, may be selected to maximize the likelihood that a majority of the return radiation will find its way to the receiver 260.

Thus, as the second motor rotates the second motor shaft 231, the second redirecting element 233 nutates at the angle (90°−α) about the second axis 234, so that a sampling of the return radiation 253 impinges upon the second redirecting element 233 and is redirected in a first redirected return column 254. Irrespective of the breadth and extent of the return radiation 253 along the second redirecting element 233, a substantial portion of the return radiation 253 will be redirected as the first redirected return column 254 onto the first redirecting element 223.

The amount of nutation depends upon the angle (90°−α). The bearing of the first redirected return column 254 depends in part upon the instantaneous rotational angle of the second redirecting element 233.

Some or all of the first reflecting return column 254 may impinge upon the facing facet 222 of the first redirecting element 223, since the range R is assumed to be small enough that the facing facet 222 will be substantially the same at launch and upon reflection.

In some respects, the facing facet 222 of the first redirecting element 223 may be said to further “sample” the first redirected return column 254. The parameters of the sensor 200, including without limitation, the FOV, the angle (90°−α), the size of the facets 222 of the first redirecting element 223 and of the second redirecting element 233 and the separation between the second redirecting element 233 and the facing facet 222 of the first redirecting element 223, may be selected to maximize the likelihood that a majority of the first redirected return column 254 will be so sampled by the facing facet 222 of the first redirecting element 223.

The facets 222 of the first redirecting element 223 are sized to ensure that a sufficient amount of the first redirected return column 254 is redirected thereon toward the third redirecting element 240 to permit detection and ranging of the target 10. The facing facet 222 of the first redirecting element 223 is sized such that when viewed from the direction of the third redirecting element 240, it appears to substantially fill and in some non-limiting examples overfill the view thereof. It will be appreciated that the separation between the second redirecting element 233 and the facing facet mirror surface 222 may consequentially impact the size of the facets 222 of the first redirecting element 223.

The first redirecting assembly 220 is positioned such that the first redirected return column 254, which is redirected off the second redirecting element 233 and proceeds unimpeded thereafter, impinges upon the facing facet 222 of the first redirecting element 223. Thus, as the first motor rotates the first motor shaft 221, the facets 222 of the first redirecting element 223 rotate about the first axis 224 of the first motor shaft 221 and the first redirected return column 254 impinges at an angle corresponding to the reflected angle (ϕᵣ) upon the facing facet 222 of the first redirecting element 223 and is redirected at an angle corresponding to the incident angle (ϕᵢ) having a magnitude equal to ϕᵣ as a second redirected return column 252 toward the third redirecting element 240. The angular redirection between the first redirected return column 254 and the second redirected return column 252 will depend upon the number n of facets 222 of the first redirecting element 223. The bearing of the second redirected return column 252 depends in part upon the instantaneous rotational angle of the second redirecting element 233 (which dictates, in part, the angle of incidence of the first redirected return column 254 on the facing facet 222 of the first redirecting element 223) and upon the instantaneous rotational angle of the facing facet 222 of the first redirecting element 223 at impingement.

The third redirecting element 240 is a fixed optical element interposed between the laser source 210 and the first redirecting assembly 220 and having an optical axis collinear with the beam axis 214. The third redirecting element 240 is oriented facing the first redirecting element 223 and configured to redirect radiation incident thereon at an angle to the beam axis 214, with a small aperture 242 allowing the launch beam 213 to pass through the third redirecting element 240 unimpeded.

In some examples, the third redirecting element 240 is a substantially planar, mirrored surface oriented at an angle to the optical axis. In some examples, the third redirecting element 240 is an offset segment of a parabolic reflecting and focusing element (not shown) configured to redirect radiation thereon at an angle to the optical axis. In some examples, the third redirecting element 240 is a refractive element (not shown) configured to redirect the radiation incident thereon (in a direction opposite to that of the launch beam 213) at an angle to the optical axis. In some examples, the angle is substantially 45°.

However implemented, the bore of the aperture 242 within the third redirecting element 240 is sized to ensure that the launch beam 213 may pass therethrough unimpeded, while substantially minimizing the amount of the second redirected return column 252 that will pass therethrough. Thus, the launch beam 213 passes through the aperture 242 to impinge unimpeded upon the facing facet 222 of the first redirecting element 223, while most if not substantially all of the second redirected return column 252 is redirected by the third redirecting element 240 as a third redirected return column 255 toward the detector 250.

In some respects, the third redirecting element 240 may be said to further “sample” the second redirected return column 252. The parameters of the sensor 200, including without limitation, the FOV, the angle (90°−α), the size of the facets 222 of the first redirecting element 223 and of the second redirecting element 233 and the separation between the second redirecting element 233 and the facing facet 222 of the first redirecting element 223, as well as the distance between the facing facet 222 of the first redirecting element 223 and the third redirecting element 240, the size and angle of the third redirecting element 240 and the size of the aperture 242, may be selected to maximize the likelihood that a majority of the second redirected return column 252 will be so sampled by the third redirecting element 240.

In some examples, an optical filter 251 and/or a focusing lens (not shown) is interposed along the path of the third redirected return column 255. If a focusing lens is employed, the third redirected return column 255 is focused as a focused beam toward a focal point proximate to a surface of the detector 250. In some examples, the focusing lens may be dispensed with, if the third redirecting element 240 is a parabolic reflecting and focusing element (not shown) or a refractive element (not shown), in which case, the third redirected return column 255 itself constitutes the focused beam focused toward the focal point proximate to the surface of the detector 250.

If employed, the filter 251 and/or the focusing lens are sized to accept and pass therethrough, substantially all of the third redirected return column 255, so that there is no “sampling” performed thereby.

Eventually, the focused beam strikes the detector 250.

The detector 250 detects the impingement of the focused beam thereon. In some examples, the detector 250 may be an avalanche photodiode (APD), a PIN Photodiode, a charge-coupled device (CCD), and/or or a receiving fibre connected thereto. The detector 250 is coupled to the receiver unit 260 such that the receiver unit 260 is able to correlate the emission of the launch beam 213 with the receipt of the focused beam corresponding thereto by the detector 250 so as to determine a range R to the target 10.

In some non-limiting examples, the detector 250 determines a time when the focused beam is detected at the detector 250. The receiver unit 260 then correlates the time that the launch beam 213 is emitted with the time at which the corresponding signal is detected at the detector 250, from which the receiver unit 260 may determine a TOF to and from the target 10, from which the range R thereto may be determined.

In some non-limiting examples, the detector 250 detects, by way of heterodyne phase detection, a phase of the focused (CW) beam, which in some non-limiting examples would be a FMCW beam. The receive unit 260 then correlates the phase at which the launch beam 213 is emitted with the phase at which the corresponding signal is detected at the detector 250, from which the receiver unit 260 may determine a heterodyne phase difference relative to the corresponding portion of the launch beam 213, from which the range R to the target 10 may be determined, although it will be appreciated that the specific configuration in such case would be different and may involve different and/or additional components from that shown in FIG. 2 and as described herein.

The receiver unit 260 is coupled to the beam source 210 by signal line 261 and to the detector 250 and accepts data therefrom that allows it to determine the range R to the target 10.

In some examples, the detector 250 may be fast enough to respond to multiple return signals from a single launch beam 213.

In some examples, the receiver unit 260 may comprise and/or be implemented by a field-programmable gate array (FPGA) coupled to the beam source 210 and the detector 250.

In some examples, the data obtained by the receiver unit 260 allows the receiver unit 260 to derive the TOF between when the (pulsed) launch beam 213 is emitted by the beam source 210 and when the (pulsed) focused beam corresponding thereto is detected at the detector 250, from which the range R to the target 10 may be determined.

The mechanism by which the TOF is determined for pulsed beams is well known. In some examples the range R may be determined from the TOF by Equation 1:

$$R = τ c / 2 ( where τ is the measured TOF and c is the speed of light ) \qquad ( 1 )$$

In some examples, the data obtained by the receiver unit 260 allows the receiver unit 260 to derive a phase difference between the (CW) launch beam 213 that is emitted by the beam source 210 and the (CW) focused beam corresponding thereto detected by way of heterodyne phase detection at the detector 250, from which the range R to the target 10 may be determined.

The mechanism by which the phase difference is determined for FMCW beams is well known.

The coordinates (a, b, c) of detection at range R relative to the A-B-C coordinate system are measured by knowing the TOF and the positions of the facing facet 222 of the first redirecting element 223 and the second redirecting element 233. Although encoders can be used to determine the positions of the facing facet 222 of the first redirecting element 223 and of the second redirecting element 233, they can be bulky and increase the cost and complexity of fabrication. In some non-limiting examples, other methods of determining the respective positions of the facing facet 222 of the first redirecting element 223 and the second redirecting element 233 can be used, including without limitation:
Hall effect combined with a clock;
Measurement of back electromotive force (EMF) from the motors combined with a clock; and
Free running motor with an exterior start trigger on every revolution to start a clock.

Thus, the operation of the detection portion of the sensor 200 may now be described. It will be appreciated that while the operation of the detection portion of the sensor 200 is being described independently of the operation of the launch portion of the sensor 200, both the launch portion and the detection portion operate simultaneously and employ common components.

The facets 222 of the first redirecting element 223 are fully and completely rotated through at least a complete revolution in a first direction and at a first constant rotational rate and the second redirecting element 233 is fully and completely and independently rotated through at least a complete revolution in a second direction and at a second constant rotational rate. The first and second directions may be the same or different and the first and second rotational rates may be the same or different. It will be appreciated that this is the same as in the operation of the launch portion of the sensor 200, described elsewhere.

Some of the return radiation 253, which comprises reflections of the second redirected launch beam 216 off the surface of the target 10, impinges on the second redirecting element 233, being redirected as the first redirected return column 254 that impinges on the facing facet 222 of the first redirecting element 223, whereupon it is redirected as the second redirected return column 252 toward the third redirecting element 240. A portion of the second redirected return column 252 is redirected by the third redirecting element 240, optionally through the filter 251 and/or focusing lens and is focused as a focused beam toward a focal point proximate to the surface of the detector 250. The detector 250 detects the focused beam and provides data to the receiving unit 260 by which the focused beam may be correlated with corresponding portions of the launch beam 213 in the launch portion (described elsewhere) of the sensor 200 to determine the range R to the target 10.

Adjusting the and/or the number n of facets 222 of the first redirecting element 223, the angle (90°−α), as well as the distance between opposing facets 222 of the first redirecting element 223 and the diameter of the second redirecting element 233, will impact the FOV achievable, perhaps even beyond the FOV shown by non-limiting example in FIG. 6.

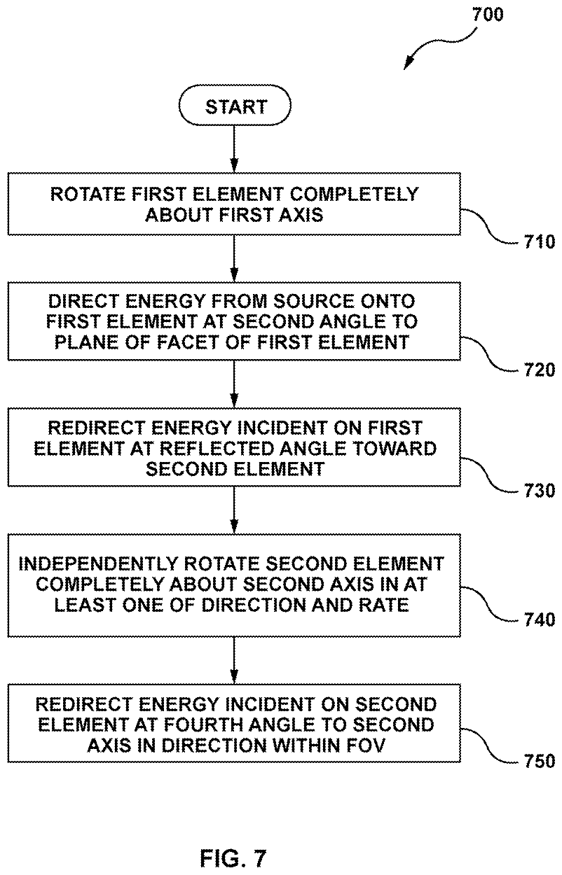

Turning now to FIG. 7, there is shown a flow chart, shown generally at 700, showing example actions to direct energy radiated from a source along a beam axis to a coordinate in an FOV defined by at least one of azimuthal and elevational orientations.

One example action 710 is to rotate a first energy-redirecting element 223 comprising a plurality n of facets 222 organized in a polygonal configuration completely about a first axis 224 that is at a first angle relative to the beam axis 214.

One example action 720 is to direct the energy 213 from the source 210 onto the first energy-redirecting element 223 at a second angle (ϕᵢ) to a plane thereof.

One example action 730 is to redirect the energy 213 incident on the first energy-redirecting element 223, at a reflected angle (ϕᵣ) having a magnitude equal to the second angle (ϕᵢ), toward a second energy-redirecting element 233.

One example action 740 is to independently rotate, in at least one of direction and rate relative to the first energy-redirecting element 223, the second energy-redirecting element 233 completely about a second axis 234 at a third angle to the beam axis 214.

One example action 750 is to further redirect the energy 215 incident on the second energy-redirecting element 233, from the first energy-redirecting element 223, at a fourth angle α to the second axis 234 in a direction within the FOV.

It will be apparent that various modifications and variations may be made to the embodiments disclosed herein, consistent with the present disclosure, without departing from the spirit and scope of the present disclosure.

In the foregoing disclosure, for purposes of explanation and not limitation, specific details are set forth such as particular architectures, interfaces, techniques, etc. in order to provide a thorough understanding of the present disclosure. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present disclosure.

The present disclosure can be implemented in digital electronic circuitry, or in computer hardware, firmware, software, or in combination thereof. Apparatus of the disclosure can be implemented in a computer program product tangibly embodied in a machine-readable storage device for execution by a programmable processor: and methods and actions can be performed by a programmable processor executing a program of instructions to perform functions of the disclosure by operating on input data and generating output.

The disclosure can be implemented advantageously on a programmable system including at least one input device, and at least one output device. Each computer program can be implemented in a high-level procedural or object-oriented programming language or in assembly or machine language, if desired; and in any case, the language can be a compiled or interpreted language. Further, the foregoing description of one or more specific embodiments does not limit the implementation of the invention to any particular computer programming language, operating system, system architecture or device architecture.

The processor executes instructions, codes, computer programs, scripts which it accesses from hard disk, optical disk (these various disk based systems may all be considered secondary storage), ROM, RAM, or the network connectivity devices. Multiple processors may be present. Thus, while instructions may be discussed as executed by a processor, the instructions may be executed simultaneously, serially, or otherwise executed by one or multiple processors.

When provided by a processor, the functions may be provided by a single dedicated processor, by a single shared processor, or by a plurality of individual processors, some of which may be shared or distributed. The functions of the various elements including functional blocks labelled as “modules”, “processors” or “controllers” may be provided through the use of dedicated hardware, as well as hardware capable of executing software in association with appropriate software with sufficient processing power, memory resources, and network throughput capability to handle the necessary workload placed upon it. Moreover, explicit use of the term “module”, “processor” or “controller” should not be construed to refer exclusively to hardware capable of executing software, and may include, without limitation, digital signal processor (DSP) hardware, read-only memory (ROM) for storing software, random access memory (RAM) and non-volatile storage.

Suitable processors include, by way of example, both general and specific microprocessors. Generally, a processor will receive instructions and data from a read-only memory or a random access memory. Generally, a computer will include one or more mass storage devices for storing data file: such devices include magnetic disks and cards, such as internal hard disks, and removable disks and cards: magneto-optical disks: and optical disks. Storage devices suitable for tangibly embodying computer program instructions and data include all forms of volatile and non-volatile memory, including by way of example semiconductor memory devices, such as EPROM, EEPROM, and flash memory devices: magnetic disks such as internal hard disks and removable disks: magneto-optical disks: CD-ROM and DVD-ROM disks; and buffer circuits such as latches or flip flops. Any of the foregoing can be supplemented by, or incorporated in ASICs (application-specific integrated circuits), FPGAs (field-programmable gate arrays), DSPs (digital signal processors) or GPUs (graphics processing units) including, without limitation, general purpose GPU¹s.

Examples of such types of computer are programmable processing systems suitable for implementing or performing the apparatus or methods of the disclosure. The system may comprise a processor, (which may be referred to as a central processor unit or CPU), which may be implemented as one or more CPU chips, and that is in communication with memory devices including secondary storage, read only memory (ROM), a random access memory, a hard drive controller, or an input/output devices or controllers, and network connectivity devices, coupled by a processor bus.

Secondary storage is typically comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage.

I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) or global system for mobile communications (GSM) radio transceiver cards, and other well-known network devices. These network connectivity devices may enable the processor to communicate with an Internet or one or more intranets. The network connectivity devices may also include one or more transmitter and receivers for wirelessly or otherwise transmitting and receiving signal as are well known. With such a network connection, it is contemplated that the processor might receive information from the network, or might output information to the network in the course of performing the above-described method steps.

Such information, which is often represented as data or a sequence of instructions to be executed using the processor for example, may be received from and outputted to the network, for example, in the form of a computer data baseband signal or signal embodied in a carrier wave. The baseband signal or signal embodied in the carrier wave generated by the network connectivity devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several well known methods.

Moreover, although some embodiments may include mobile devices, not all embodiments are limited to mobile devices: rather, various embodiments may be implemented within a variety of communications devices or terminals, including handheld devices, mobile telephones, personal digital assistants (PDAs), personal computers, audio-visual terminals, televisions and other devices.

In some instances, detailed descriptions of well-known devices, circuits, and methods are omitted so as not to obscure the description of the present disclosure with unnecessary detail. All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

While the present disclosure is sometimes described in terms of methods, a person of ordinary skill in the art will understand that the present disclosure is also directed to various apparatus including components for performing at least some of the aspects and features of the described methods, be it by way of hardware components, software or any combination of the two, or in any other manner.

Certain terms are used throughout to refer to particular components. Manufacturers may refer to a component by different names. Use of a particular term or name is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” or “communicate” in any form are intended to mean either a direct connection or indirect connection through some interface, device, intermediate component or connection, whether electrically, mechanically, chemically, or otherwise.

Directional terms such as “upward”, “downward”, “left” and “right” are used to refer to directions in the drawings to which reference is made unless otherwise stated. Similarly, words such as “inward” and “outward” are used to refer to directions toward and away from, respectively, the geometric center of a device, area or volume or designated parts thereof. Moreover, all dimensions described herein are intended solely to be by way of example for purposes of illustrating certain embodiments and are not intended to limit the scope of the disclosure to any embodiments that may depart from such dimensions as may be specified.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated that block diagrams reproduced herein can represent conceptual views of illustrative components embodying the principles of the technology.

The purpose of the Abstract is to enable the relevant patent office or the public generally, and specifically, persons of ordinary skill in the art who are not familiar with patent or legal terms or phraseology, to quickly determine from a cursory inspection, the nature of the technical disclosure. The Abstract is neither intended to define the scope of this disclosure, which is measured by its claims, nor is it intended to be limiting as to the scope of this disclosure in any way.

The structure, manufacture and use of the presently disclosed embodiments have been discussed above. While example embodiments are disclosed, this is not intended to be limiting the scope of the presently described embodiments. It should be appreciated, however that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

In particular, features from one or more of the above-described embodiments may be selected to create alternative embodiments comprised of a sub-combination of features that may not be explicitly described above. In addition, features from one or more of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

Further, the various elements or components may be combined or integrated in another system or certain features may be omitted, or not implemented. Also, techniques, systems, subsystems and methods described and illustrated in the various embodiments as discrete or separate may be combined or integrated with other systems, modules, techniques, or methods without departing from the scope of the present disclosure. Other examples of changes, substitutions, and alterations are easily ascertainable and could be made without departing from the scope disclosed herein.

It will be apparent that various modifications and variations covering alternatives, modifications and equivalents will be apparent to persons having ordinary skill in the relevant art upon reference to this disclosure and the practice of the embodiments disclosed therein and may be made to the embodiments disclosed herein, without departing from the present disclosure, as defined by the appended claims.

Other embodiments consistent with the present disclosure will be apparent from consideration of the specification and the practice of the disclosure disclosed herein. Accordingly the specification and the embodiments disclosed therein are to be considered examples only, with a true scope and spirit of the disclosure being disclosed by the following numbered claims:

1. A head for directing energy radiated from a source along a beam axis to a coordinate in a field of view (FOV) defined by at least one of azimuth and elevational orientations, comprising:
a first energy-redirecting element comprising a plurality of facets organized in a polygonal configuration, the facets being fully rotatable about a first axis that is at a first non-zero angle relative to the beam axis, for rotating the facets about the first axis, receiving the radiated energy incident along the beam axis on a facet facing the source at a second angle to a plane of the facet and redirecting it at a reflected angle having a magnitude equal to the second angle as the first energy-redirecting element is rotated; and
a second energy-redirecting element fully and independently rotatable, in at least one of direction and rate relative to the first energy-redirecting element, about a second axis at a third angle to the beam axis, for receiving the redirected energy incident thereon and further redirecting it at a fourth angle to the second axis as it is rotated, in a direction within the FOV;
wherein the second axis is at a non-zero angle other than substantially 90° with each of the beam axis and the first axis.

2. A head according to claim 1, wherein the FOV has a substantially rectangular shape oriented along its azimuthal and elevational orientations thereof.

3. A head according to claim 1, wherein the first energy-redirecting element is associated with a controlled orientation of the FOV and the second energy-redirecting element is associated with an uncontrolled orientation of the FOV.

4. A head according to claim 3, wherein the FOV extends substantially 85° along the controlled orientation thereof.

5. A head according to claim 3, wherein the FOV extends substantially 21° along the uncontrolled orientation thereof.

6. A head according to claim 1, wherein the first angle is substantially 90°.

7. A head according to claim 1, wherein the facets define a regular polygon about a plane substantially normal to the first axis.

8. A head according to claim 1, wherein the facets are each mirror surfaces for reflecting the radiated energy incident thereon at the reflected angle.

9. A head according to claim 1, wherein a third axis, the beam axis and the first axis define a right-handed cartesian coordinate system.

10. A head according to claim 9, wherein each of the facets substantially define a plane having an associated normal vector.

11. A head according to claim 10, wherein the plane of each facet is substantially parallel to the first axis and the associated normal vectors all lie in a common plane normal to the first axis.

12. A head according to claim 11, wherein the common plane is defined by the third axis and the beam axis and the first energy-redirecting element is associated with the azimuthal orientation of the FOV.

13. A head according to claim 12, wherein the common plane is defined by the beam axis and the first axis and the second energy-redirecting element is associated with the elevational orientation of the FOV.

14. A head according to claim 11, wherein at least one facet is offset by a facet offset angle relative to the first axis.

15. (canceled)

16. A head according to claim 9, wherein a projection of the second axis onto a first plane defined by the third axis and the beam axis is substantially along the third axis and a projection of the second axis onto a second plane defined by the third axis and the first axis is substantially at 45° with the first axis.

17. A head according to claim 16, wherein the second axis is subjected to at least one positioning adjustment relative to the projection thereof onto at least one of the first and second planes.

18. A head according to claim 1, wherein the fourth angle is substantially between 0° and 15°.

19. A head according to claim 1, wherein the second energy-redirecting element is a second mirror surface.

20. A head according to claim 19, wherein the second energy redirecting element is a substantially circular wedge mirror angled at the fourth angle relative to a base normal to the second axis.

21. A method for directing energy radiated from a source along a beam axis to a coordinate in a field of view (FOV) defined by at least one of azimuthal and elevational orientations, comprising actions of:
rotating a first energy-redirecting element comprising a plurality of facets organized in a polygonal configuration completely about a first axis that is at a first non-zero angle relative to the beam axis;
directing the energy from the source onto the first energy-redirecting element at a second angle to a plane thereof;
redirecting the energy incident on the first energy-redirecting element, at a reflected angle. Having a magnitude equal to the second angle, toward a second energy-redirecting element;
independently rotating, in at least one of direction and rate relative to the first energy-redirecting element, the second energy-redirecting element completely about a second axis at a third angle relative to the beam axis, wherein the second axis is at a non-zero angle other than substantially 90° with each of the beam axis and the first axis; and
further redirecting the energy incident on the second energy-redirecting element, from the first energy-redirecting element, at a fourth angle to the second axis in a direction within the FOV.
